(19) United States
(12) Patent Application Publication
(10) Pub. No.: US 2025/0091430 A1
(43) Pub. Date: Mar. 20, 2025

(54) ALL-TERRAIN VEHICLE AND ASSEMBLY THEREOF

(71) Applicant: Segway Technology Co., Ltd., Changzhou (CN)

(72) Inventors: Zhaowei WANG, Changzhou (CN); Wei WANG, Changzhou (CN)

(21) Appl. No.: 18/828,601

(22) Filed: Sep. 9, 2024

(30) Foreign Application Priority Data
Sep. 19, 2023 (CN) 202322549311.0
Sep. 20, 2023 (CN) 202322570356.6
Sep. 27, 2023 (CN) 202311273590.0
Sep. 27, 2023 (CN) 202322650246.0

(51) Int. Cl. B60K 11/04; B60K 6/40; B60K 11/08; B60R 21/13; B62D 21/02

(52) U.S. Cl. CPC B60K 11/04; B60K 6/40; B60K 11/08; B60R 21/13; B62D 21/02; B60Y 2200/92

(57) ABSTRACT

An all-terrain vehicle is provided, including a frame, a motor, and a motor heat dissipation assembly; along a first direction, the frame includes a first transverse beam located in a middle thereof, a first space is formed between the first transverse beam and a front of the frame, and a second space is formed between the first transverse beam and a rear of the frame; the motor is arranged in the second space, and the motor heat dissipation assembly is located on a side of the first transverse beam facing the second space; the first space has an air inlet connected with the motor heat dissipation assembly, and the motor heat dissipation assembly is connected with the motor to cool the motor.

### CROSS-REFERENCE TO RELATED APPLICATIONS

The present application claims priority to Chinese Patent Application No. 202322549311.0, filed with the China National Intellectual Property Administration on Sep. 19, 2023, entitled “All-Terrain Vehicle”, Chinese Patent Application No. 202322570356.6, filed with the China National Intellectual Property Administration on Sep. 20, 2023, entitled “Roll Cage And All-Terrain Vehicle”, Chinese Patent Application No. 202311273590.0, filed with the China National Intellectual Property Administration on Sep. 27, 2023, entitled “All-Terrain Vehicle”, and Chinese Patent Application No. 202322650246.0, filed with the China National Intellectual Property Administration on Sep. 27, 2023, entitled “Frame And All-Terrain Vehicle Thereof”. The disclosures of the aforementioned applications are hereby incorporated by reference in their entireties.

### TECHNICAL FIELD

The present application relates to the field of vehicle technology, and in particular to an all-terrain vehicle and an assembly thereof.

### BACKGROUND

All-terrain vehicles are used to carry one or more passengers and the all-terrain vehicles have good off-road performance. Thus, there is growing recreational interest in the market for the all-terrain vehicles, for example, some of the all-terrain vehicles are gradually becoming suitable for activities such as sports and recreation, and racing, etc.

### SUMMARY

In a first aspect of embodiments in the present application, an all-terrain vehicle is provided, including a frame, a motor, and a motor heat dissipation assembly; where along a first direction, the frame includes a first transverse beam located at a middle thereof, a first space is formed between the first transverse beam and a front of the frame, and a second space is formed between the first transverse beam and a rear of the frame; the motor is arranged in the second space, and the motor heat dissipation assembly is located on a side of the first transverse beam facing the second space; and the first space has an air inlet connected with the motor heat dissipation assembly, and the motor heat dissipation assembly is connected with the motor to cool the motor.

For the all-terrain vehicle provided in the first aspect of the embodiments in the present application, by arranging the motor heat dissipation assembly at the middle of the frame, a part of a front space of a front end of the all-terrain vehicle can be freed up, difficulty of a layout of a cooling system in the front can be reduced, and a layout of the whole vehicle can be further optimized. Further, a distance between the motor and a motor radiator can be shortened, to cause a path of a circulating pipeline between the motor and the motor radiator to be shorter, which avoids a loss of cold capacity, improves a heat dissipation effect, and saves costs.

In an optional embodiment, the first space is provided with a driver seat and a passenger seat along a second direction; the motor heat dissipation assembly is located at a rear side of the driver seat and the passenger seat along the first direction; and the motor heat dissipation assembly is located between the driver seat and the passenger seat along the second direction, and the air inlet is formed between the driver seat and the passenger seat.

In an optional embodiment, along the first direction, the motor heat dissipation assembly is obliquely mounted on the first transverse beam, and an inclination angle ranges from 30° to 60°; where the all-terrain vehicle further includes an engine; the engine is arranged in the second space and is located above the motor; and an air outlet of the motor heat dissipation assembly is located opposite to the engine.

In an optional embodiment, the motor heat dissipation assembly includes a first radiator and a fan; the motor has a heat dissipation cavity, one end of the first radiator is connected with an inlet of the heat dissipation cavity; and the other end of the first radiator is connected with an outlet of the heat dissipation cavity, and there is a cooling medium between the motor and the first radiator; and the first radiator is connected to the first transverse beam, and the fan is arranged on a side of the first radiator facing the second space.

In an optional embodiment, the all-terrain vehicle further includes a support frame, a second transverse beam, and a first support beam; along a third direction, the second transverse beam is arranged below the first transverse beam, and the first support beam is connected between the first transverse beam and the second transverse beam; the support frame is arranged along the first direction, one end thereof is connected to the rear of the frame, and the other end thereof is connected to the second transverse beam; and the first radiator is connected to the first transverse beam, the support frame, and the first support beam.

In an optional embodiment, the support frame is provided with a first mounting frame; the first mounting frame extends along the third direction, one end of the first mounting frame is connected to the support frame, and the other end of the first mounting frame is connected to a bottom of the first radiator; the first support beam is provided with a second mounting frame, and the second mounting frame is used for connecting to the bottom of the first radiator; the first transverse beam is provided with at least two first fixing seats which are spaced apart along the second direction; and the first fixing seats are used for connecting to a top of the first radiator.

In an optional embodiment, the first radiator has a first fixing frame, a second fixing frame, a third fixing frame, and a fourth fixing frame; the first radiator is a rectangular plate structure in overall, the first fixing frame and the second fixing frame are arranged at the top of the first radiator along the third direction, and the first fixing frame and the second fixing frame are respectively located on two sides of the first radiator along the second direction; the first fixing frame and the second fixing frame are configured to be connected to the first transverse beam; the third fixing frame and the fourth fixing frame are arranged at the bottom of the first radiator along the third direction, and the third fixing frame and the fourth fixing frame are respectively located on the two sides of the first radiator along the second direction; and the third fixing frame and the fourth fixing frame are configured to be respectively connected to the support frame and the first support beam.

In a second aspect of the embodiments in the present application, a roll cage is provided, mounted on a top of a frame, and including a middle beam assembly, two side beams, and a support beam assembly; where the two side beams are respectively connected to two sides of the middle beam assembly along a second direction, the middle beam assembly includes at least two third transverse beams, and two of the third transverse beams are spaced apart along a first direction; the third transverse beams extend along the second direction and two ends thereof are respectively connected to the side beams; the support beam assembly includes at least two second support beams, one end of each of the second support beams is respectively connected to the side beams, and other end of each of the second support beams is respectively connected to the frame, and the frame, the side beams, and the second support beams enclose closed triangular structures.

The roll cage provided in the second aspect of the embodiments in the present application includes the middle beam assembly, the support beam assembly, and the side beams arranged on the two sides of the middle beam assembly, where the middle beam assembly is connected to the side beams, the second support beams of the support beam assembly are arranged between the frame and the side beams, and the second support beams enclose a closed triangular structure with the frame and the side beams. Such an arrangement can enhance structural strength of the entire roll cage, thereby enhancing an ability of the roll cage to withstand lateral impacts and rolling impacts, reducing risks of deformation and breakage of the roll cage, and improving safety of the all-terrain vehicle.

In an optional embodiment, the side beams extend along the first direction, and a side of each of the side beams facing the third transverse beams is provided with a first mounting seat; an end of each of the third transverse beams is provided with a second mounting seat connected to the first mounting seat, the first mounting seat has a first mounting surface, and the second mounting seat has a second mounting surface; the first mounting surface and the second mounting surface are arranged oppositely and fit together along the second direction; a fastener is arranged between the first mounting seat and the second mounting seat; and a mounting direction of the fastener is consistent with the second direction.

In an optional embodiment, two of the second support beams are arranged obliquely between the frame and the side beams along the second direction; and the two of the second support beams are arranged obliquely and symmetrically along the first direction.

In an optional embodiment, the middle beam assembly further includes at least one fourth transverse beam; where the fourth transverse beam is arranged between two adjacent third transverse beams of the third transverse beams, and the fourth transverse beam extends along the first direction; the two side beams are symmetrically arranged in a splayed shape along the first direction, and a width between the two side beams along the second direction gradually decreases from a front to a rear of the frame; each of the side beams respectively includes a first tubular column, a second tubular column, and at least one third tubular column; where the first tubular column extends along the first direction, and two ends thereof are respectively connected to the front and the rear of the frame; the second tubular column is arranged on an outer side of the first tubular column along the second direction, one end of the second tubular column is connected to the first tubular column, and the other end thereof extends along a third direction and is connected to a middle of the frame; the third tubular column is arranged obliquely along the first direction, one end thereof is connected to the second tubular column, and the other end thereof is connected to the first tubular column, and the first tubular column, the second tubular column, and the third tubular column enclose a closed triangular structure.

In an optional embodiment, each of the side beams includes one third tubular column; and the third tubular column is provided on a side of the second tubular column facing the rear of the frame along the first direction.

In an optional embodiment, one end of each of the second support beams is connected to the middle of the frame, and the other end thereof is connected to the second tubular column; and the first tubular column, the second tubular column, and the third tubular column are a one-piece structure.

In a third aspect of the embodiments in the present application, an all-terrain vehicle is provided, including a frame and the roll cage as described in the second aspect; where the roll cage is arranged on a top of the frame along the third direction, and the roll cage is detachably connected to the front, the middle, and the rear of the frame, respectively, along the second direction.

The all-terrain vehicle provided in the third aspect of the embodiments in the present application includes the frame and the roll cage, where the roll cage includes the middle beam assembly, the support beam assembly, and the side beams arranged on the two sides of the middle beam assembly, the middle beam assembly is connected to the side beams, the second support beams of the support beam assembly are arranged between the frame and the side beams, and the second support beams enclose a closed triangular structure with the frame and the side beams. Such an arrangement can enhance structural strength of the entire roll cage, thereby enhancing an ability of the roll cage to withstand lateral impacts and rolling impacts, reducing risks of deformation and breakage of the roll cage, and improving safety of the all-terrain vehicle.

In a fourth aspect of the embodiments in the present application, an frame is provided, including: a first support frame, a second support frame, and first vertical beam assemblies used for connecting the first support frame to the second support frame; where the first support frame includes two first support longitudinal beams spaced apart along a second direction and a fifth transverse beam used for connecting the two first support longitudinal beams, and the second direction is a width direction of the frame; each of the first support longitudinal beams is connected to the second support frame via one of the first vertical beam assemblies; two of the first vertical beam assemblies, the two first support longitudinal beams, and the fifth transverse beam enclose a first mounting space in a triangular shape; and the first mounting space is used for mounting a balancing pole.

In the frame provided in the fourth aspect of the embodiments in the present application, by arranging the fifth transverse beam between the two first support longitudinal beams, the two of the first vertical beam assemblies, the two first support longitudinal beams, and the fifth transverse beam enclose the first mounting space in the triangular shape. Such an arrangement reasonably optimizes a space between the first support frame and the second support frame, and divides the space between the first support frame and the second support frame into the first mounting space and a remaining space located above the first mounting space, thereby facilitating mounting of the balancing pole in the first mounting space, and mounting of other structures in the remaining space, which achieves advantages of reasonably optimizing a mounting space of the frame and improving strength and stiffness of the frame. In an optional embodiment, the frame is a front frame.

In an optional embodiment, the first support frame further includes a sixth transverse beam, where the sixth transverse beam and the fifth transverse beam are spaced apart along a first direction; one end of the sixth transverse beam is connected to one of the first support longitudinal beams, and the other end of the sixth transverse beam is connected to the other first support longitudinal beam; where the first direction is a driving direction of the all-terrain vehicle; and each of the first vertical beam assemblies includes a first vertical beam and a second vertical beam spaced apart along the first direction.

In an optional embodiment, the frame further includes a third support frame, where the third support frame is arranged on a side of the first support frame away from the second support frame and is connected to at least the first support frame; the frame further includes a second vertical beam assembly and a mounting plate assembly; the second vertical beam assembly and the mounting plate assembly are spaced apart along the first direction, and the mounting plate assembly and the second vertical beam assembly are both used for connecting the first support frame and the third support frame; the second vertical beam assembly, the mounting plate assembly, the first support frame, and the third support frame enclose a second mounting space, and the second mounting space is used for mounting a steering mechanism; the mounting plate assembly, the first support frame, and the third support frame enclose a third mounting space, and the third mounting space is used for mounting a front axle assembly.

In an optional embodiment, the second vertical beam assembly includes a third vertical beam and a fourth vertical beam, where the third vertical beam and the fourth vertical beam are spaced apart along the second direction, one end of the third vertical beam and one end of the fourth vertical beam are connected to the first support frame, and the other ends are both connected to the third support frame.

In an optional embodiment, the mounting plate assembly includes a first mounting plate and a second mounting plate spaced apart along the second direction, where one end of the first mounting plate and one end of the second mounting plate are connected to the third support frame, and the other end of the first mounting plate and the other end of the second mounting plate are connected to the first support frame; the first mounting plate and the second mounting plate are both provided with a mounting hole, and two mounting holes are arranged in counterpoint; the frame further includes a third mounting plate and at least two mounting supports; the mounting plate assembly, the third mounting plate, and the at least two mounting supports are used for connecting to the front axle assembly; the third mounting plate is arranged at a bottom of the third support frame and is connected to the mounting plate assembly; one of the mounting supports is arranged on the first mounting plate, and the other one of the mounting supports is arranged on the second mounting plate and is located on a side of the mounting holes away from the third support frame.

In an optional embodiment, the frame further includes two oblique support members, where the two oblique support members are spaced apart along the second direction, respectively located on two sides of the third support frame and connected to the third support frame.

In a fifth aspect of the embodiments in the present application, an all-terrain vehicle is provided, including: the frame as described in the above fourth aspect and in the optional embodiments of the fourth aspect and a balancing pole, and the balancing pole is mounted in the first mounting space of the frame.

In the all-terrain vehicle provided in the fifth aspect of the embodiments in the present application, by arranging the fifth transverse beam between the two first support longitudinal beams, the two of the first vertical beam assemblies, the two first support longitudinal beams, and the fifth transverse beam enclose the first mounting space in the triangular shape. Such an arrangement reasonably optimizes the space between the first support frame and the second support frame, and divides the space between the first support frame and the second support frame into the first mounting space and the remaining space located above the first mounting space, thereby facilitating the mounting of the balancing pole in the first mounting space, and the mounting of the other structures in the remaining space, which achieves the advantages of reasonably optimizing the mounting space of the frame and improving the strength and the stiffness of the frame.

In an optional embodiment, the all-terrain vehicle further includes a front axle assembly, a second radiator, a steering mechanism, and a bumper; where the front axle assembly is mounted in the third mounting space of the frame, and the steering mechanism is mounted in the second mounting space of the frame; the second radiator is respectively connected to the second support frame and the third support frame of the frame via a radiator support; and the bumper is connected to a front of the third support frame.

In a sixth aspect of the embodiments in the present application, an all-terrain vehicle is provided, including a frame, a balancing pole, a steering mechanism, a front axle assembly, and a plurality of wheels supporting the frame, where the frame includes a front frame, a middle frame, and a rear frame which extend along a first direction, the front frame includes at least a first mounting space, a second mounting space, and a third mounting space, the balancing pole is mounted in the first mounting space, the steering mechanism is mounted in the second mounting space, and the front axle assembly is mounted in the third mounting space; the first mounting space is located above the second mounting space along a third direction, and the second mounting space and the third mounting space are arranged sequentially along the first direction; where the first direction is a driving direction of the all-terrain vehicle; and the third direction is a height direction of the all-terrain vehicle.

In the all-terrain vehicle provided in the sixth aspect of the embodiments in the present application, by improving a structure of the front frame, where the front frame includes at least the first mounting space, the second mounting space, and the third mounting space, the first mounting space is located above the second mounting space along the third direction, and the second mounting space and the third mounting space are arranged sequentially along the first direction, so that the first mounting space, the second mounting space, and the third mounting space form a structure similar to a triangle. Such an arrangement reasonably optimizes a mounting space of the front frame and improves strength and stiffness of the front frame, which improves structure stability of the frame.

In an optional embodiment, the front frame includes: a first support frame, a second support frame, and first vertical beam assemblies used for connecting the first support frame to the second support frame; where the first support frame includes two first support longitudinal beams spaced apart along a second direction and a fifth transverse beam used for connecting the two first support longitudinal beams, and the second direction is a width direction of the frame; each of the first support longitudinal beams is connected to the second support frame via one of the first vertical beam assemblies; and two of the first vertical beam assemblies, the two first support longitudinal beams, and the fifth transverse beam enclose the first mounting space in a triangular shape.

In an optional embodiment, the first support frame further includes a sixth transverse beam, where the sixth transverse beam and the fifth transverse beam are spaced apart along the first direction; one end of the sixth transverse beam is connected to one of the first support longitudinal beams, and the other end of the sixth transverse beam is connected to the other one of the first support longitudinal beams; where the first direction is a driving direction of the front frame; and each of the first vertical beam assemblies includes a first vertical beam and a second vertical beam spaced apart along the first direction.

In an optional embodiment, the front frame further includes a third support frame, where the third support frame is arranged on a side of the first support frame away from the second support frame and is connected to at least the first support frame.

In an optional embodiment, the front frame further includes a second vertical beam assembly and a mounting plate assembly; the second vertical beam assembly and the mounting plate assembly are spaced apart along the first direction, and both the mounting plate assembly and the second vertical beam assembly are used for connecting the first support frame to the third support frame; the second vertical beam assembly, the mounting plate assembly, the first support frame, and the third support frame enclose the second mounting space, and the second mounting space is used for mounting a steering mechanism; and the mounting plate assembly, the first support frame, and the third support frame enclose the third mounting space, and the third mounting space is used for mounting the front axle assembly.

In an optional embodiment, the second vertical beam assembly includes a third vertical beam and a fourth vertical beam, where the third vertical beam and the fourth vertical beam are spaced apart along the second direction, one end of the third vertical beam and one end of the fourth vertical beam are connected to the first support frame, and the other ends are both connected to the third support frame.

In an optional embodiment, the mounting plate assembly includes a first mounting plate and a second mounting plate spaced apart along the second direction, where one end of the first mounting plate and one end of the second mounting plate are connected to the third support frame, and the other end of the first mounting plate and the other end of the second mounting plate are connected to the first support frame; the first mounting plate and the second mounting plate are both provided with a mounting hole, and two mounting holes are arranged in counterpoint.

In an optional embodiment, the front frame further includes a third mounting plate and at least two mounting supports; the mounting plate assembly, the third mounting plate, and the at least two mounting supports are used for connecting to the front axle assembly; the third mounting plate is arranged at a bottom of the third support frame and is connected to the mounting plate assembly; one of the mounting supports is arranged on the first mounting plate, and the other one of the mounting supports is arranged on the second mounting plate and is located on a side of the mounting holes away from the third support frame.

In an optional embodiment, the front frame further includes two oblique support members, where the two oblique support members are spaced apart along the second direction, respectively located on two sides of the third support frame and connected to the third support frame.

In an optional embodiment, the all-terrain vehicle further includes a second radiator and a bumper; where the second radiator is respectively connected to the second support frame and the third support frame of the front frame via a radiator support; and the bumper is connected to a front of the third support frame.

In addition to technical problems solved by the embodiments of the present disclosure, technical features which constitute technical solutions, and beneficial effects brought about by the technical features of the technical solutions which are described above, other technical problems which can be solved by the all-terrain vehicle, the frame and the roll cage provided by the embodiments of the present disclosure, other technical features included in the technical solutions, and beneficial effects brought about by these technical features will be further described in detail in the detailed description of the embodiments.

### BRIEF DESCRIPTION OF DRAWINGS

To describe the embodiments of the present application or technical solutions in the prior art more clearly, the following briefly introduces drawings required for describing the embodiments or describing the prior art. Obviously, the drawings in following descriptions are merely some embodiments of the present application, and a person of ordinary skill in the art may still derive other drawings from these drawings without creative efforts.

FIG. 1 is an axonometric diagram of an all-terrain vehicle provided by an embodiment of the present application.

FIG. 2 is a side view of the all-terrain vehicle provided in the embodiment of the present application.

FIG. 3 is a front view of the all-terrain vehicle provided by the embodiment of the present application.

FIG. 4 is a top view of the all-terrain vehicle provided by the embodiment of the present application.

FIG. 5 is a first assembly diagram of a motor heat dissipation assembly and a frame provided by an embodiment of the present application.

FIG. 6 is a second assembly diagram of the motor heat dissipation assembly and the frame provided by the embodiment of the present application.

FIG. 7 is a third assembly diagram of the motor heat dissipation assembly and the frame provided by the embodiment of the present application.

FIG. 8 is an axonometric diagram of a frame when assembled with a roll cage provided by an embodiment of the present application.

FIG. 9 is a front view of the frame when assembled with the roll cage provided by the embodiment of the present application.

FIG. 10 is a top view of the frame when assembled with the roll cage provided by the embodiment of the present application.

FIG. 11 is a side view of the frame when assembled with the roll cage provided by the embodiment of the present application.

FIG. 12 is a stereogram of a frame provided by an embodiment of the present application.

FIG. 13 is a side view of the frame provided by the embodiment of the present application.

FIG. 14 is a stereogram of a frame and a balancing pole provided by an embodiment of the present application.

FIG. 15 is a stereogram of a frame and a front axle assembly provided by an embodiment of the present application.

FIG. 16 is a side view of the frame and the front axle assembly provided by the embodiment of the present application.

FIG. 17 is a bottom view of the frame and the front axle assembly provided by the embodiment of the present application.

FIG. 18 is an exploded view of an all-terrain vehicle provided by an embodiment of the present application.

FIG. 19 is a stereogram of the all-terrain vehicle provided by the embodiment of the present application.

FIG. 20 is a side view of the all-terrain vehicle provided by the embodiment of the present application.

FIG. 21 is a bottom view of the all-terrain vehicle provided by the embodiment of the present application.

### DESCRIPTION OF REFERENCE SIGNS

10, 90—frame; 101—first space; 102—second space; 103—air inlet;
11—first transverse beam; 111—first fixing seat;
12—second transverse beam;
13—first support beam;
14—support frame; 141—first frame; 142—second frame; 143—third frame; 144—fourth frame;
15—first mounting frame;
20—motor heat dissipation assembly;
21—first radiator; 211—fixing frame;
22—fan;
30—motor;
40—engine;
50—roll cage;
60—middle beam assembly; 61—third transverse beam; 62—fourth transverse beam; 63—second mounting seat;
70—side beam; 71—first tubular column; 72—second tubular column; 73—third tubular column; 74—first mounting seat;
710—first mounting point;
720—second mounting point;
730—third mounting point;
80—second support beam;
100: first support frame; 1001: first support longitudinal beam; 1002: fifth transverse beam; 1003: sixth transverse beam;
110: second support frame; 1101: U-shaped frame; 1102: seventh transverse beam; 1103: reinforcing beam;
120: first vertical beam assembly; 1201: first vertical beam; 1202: second vertical beam;
130: third support frame;
140: second vertical beam assembly;
150: mounting plate assembly; 151: first mounting plate; 152: second mounting plate; 153: mounting hole;
160: vertical column;
170: balancing pole;
180: steering mechanism;
190: front axle assembly;
200: third mounting plate;
210: mounting support;
220: oblique support member; 2201: oblique support beam; 2202: second support longitudinal beam;
230: eighth transverse beam;
240: connecting beam;
250: reinforcing plate;
260: second radiator;
270: bumper;
280: radiator support.

### DESCRIPTION OF EMBODIMENTS

In related art, all-terrain vehicles adopt a hybrid drive mode, and power units thereof are composed of a motor and an engine which assist each other in outputting power to achieve energy-saving effects, which greatly improves power performance of the vehicles. Due to the increase in power, a consequent heat management has also become a major problem. A hybrid vehicle is equipped with a power battery, where the power battery is greatly affected by temperature, and charging power and discharging power are lower at high and low temperatures. In order to maintain a good state of the power battery and control the temperature of the power battery to be within a certain range, a reasonable thermal management heat dissipation system is required to balance temperatures of a motor, an engine, the power battery, etc. For this reason, a head cooling system is typically mounted on a windward side of a front end of an all-terrain vehicle. However, layout designs of head cooling systems of all-terrain vehicles in the related art are relatively complicated, and heat dissipation effects of motors are poor. The inventor has found that the reason for this problem is that in an all-terrain vehicle in the related art, a head cooling system is often mounted on a windward side of a front end of the vehicle, where the head cooling system includes a liquid cooling radiator and superimposed components such as a motor radiator, an engine radiator, a fan, etc., where the liquid cooling radiator is configured to dissipate heat from a power battery, the engine radiator is configured to dissipate heat from an engine, and the motor radiator is configured to dissipate heat from a motor. As a result, a head space of the all-terrain vehicle is limited, leading to a relatively complex layout design of the head cooling system, and a distance between the motor and the motor radiator is relatively long, resulting in a relatively large loss of cooling capacity, which affects a heat dissipation effect of the motor.

For the above technical problems, a new all-terrain vehicle is provided in the embodiments of the present application, by arranging a motor heat dissipation assembly on a first transverse beam located at a middle of a frame, where the motor heat dissipation assembly is located on a rear side of the first transverse beam, that is, the motor heat dissipation assembly is arranged on a side of the middle of the frame away from a front end of the vehicle along a first direction (front and rear directions) of the all-terrain vehicle. Such an arrangement can free up a part of front space of the front end of the all-terrain vehicle, which can reduce the layout difficulty of a head cooling system and further optimize a layout of the whole vehicle.

Further, a distance between a motor and a motor radiator can be shortened to cause a path of a circulating pipeline between the motor and the motor radiator to become shorter, which avoids a loss of cold capacity, improves heat dissipation effects, and saves costs.

First of all, in order to facilitate descriptions of the embodiments in the present application, a coordinate system in the drawings is firstly explained, where an X-axis direction is defined as a first direction, which may be a driving direction of an all-terrain vehicle, i.e., front and rear directions; a Y-axis direction is defined as a second direction, which may be left and right directions of the all-terrain vehicle, i.e., the second direction is consistent with a width direction of the all-terrain vehicle, that is, the second direction is a width direction of a front frame; and a Z-axis direction is defined as a third direction, which may be defined as upper and lower directions of the all-terrain vehicle, i.e., the third direction is consistent with a height direction of the all-terrain vehicle, that is, the third direction is a height direction of the front frame.

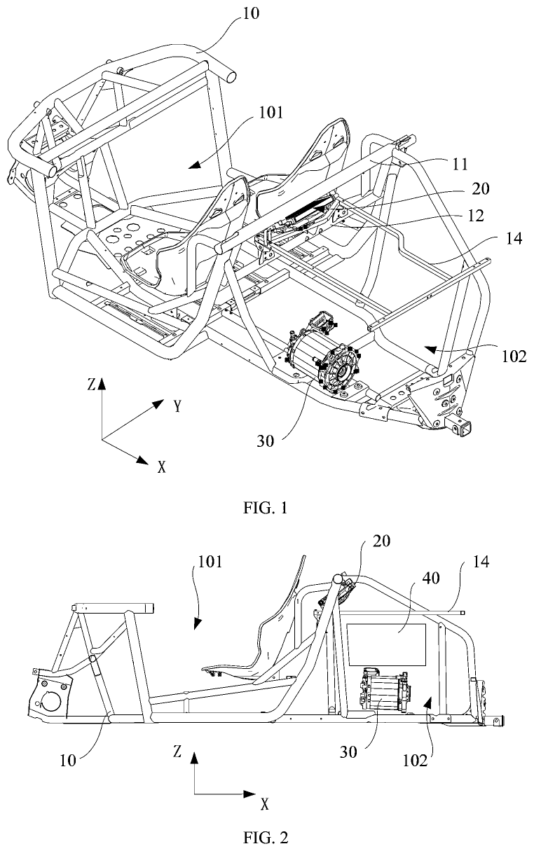

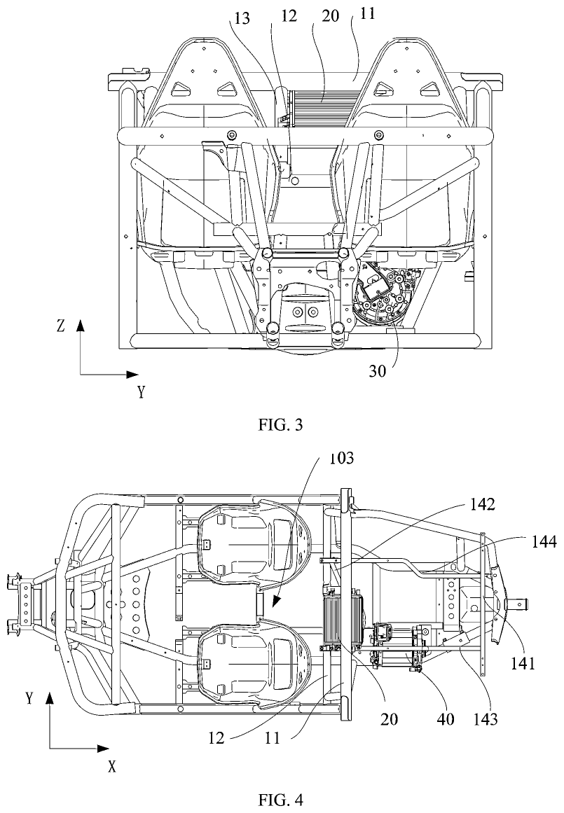

As shown in FIGS. 1 to 4, an all-terrain vehicle provided in an embodiment of the present application may be a hybrid all-terrain vehicle, including a power battery, a motor 30 and an engine 40, where the power battery is configured to provide a driving current to the motor 30, and the motor 30 is a drive motor, and the motor 30 and the engine 40 assist each other in outputting power to achieve energy-saving effects, thereby greatly improving power performance of the vehicle. At the same time, as power increases, the heat generated increases, and a thermal management cooling system is required to balance temperatures of the motor 30, the engine 40, and the power battery.

The thermal management cooling system includes a head cooling system arranged at a front end of the all-terrain vehicle. The head cooling system includes a liquid cooling radiator, an engine radiator, and an motor radiator, where a frame 10 includes a front, a middle, and a rear along a first direction; where a first space 101 is formed between the front and the middle of the frame 10, and the first space 101 may be configured to be a cab; and a second space 102 is formed between the middle and the rear of the frame 10, and the second space 102 is used for arranging the motor 30, the engine 40, etc., i.e., the second space 102 is an equipment compartment instead of a usual rear passenger space, and a passenger and a driver seat in the cab.

The aforementioned liquid cooling radiator is usually arranged on a windward side of a front (front end) of the frame 10, where the liquid cooling radiator is configured to dissipate heat from the power battery; the engine radiator is also arranged in a front space of the front end, and the engine radiator is configured to dissipate heat from the engine 40. It should be noted that the liquid cooling radiator and the engine radiator are connected with a refrigeration component of the thermal management cooling system, and the refrigeration component includes but is not limited to a water cooling component, etc.

Further, the motor heat dissipation assembly 20 is arranged in the middle of the frame 10 and is not arranged in a front space of the front end of the frame 10. The middle of the frame 10 is provided with a first transverse beam 11, the first transverse beam 11 extends along a second direction, a space between the first transverse beam 11 and the front of the frame 10 is the aforementioned first space 101, and a space between the first transverse beam 11 and the rear of the frame 10 is the second space 102.

The motor heat dissipation assembly 20 is mounted on the first transverse beam 11 and is located on a side of the first transverse beam 11 facing the second space 102. The motor heat dissipation assembly 20 includes a first radiator 21 and a fan 22, where the first radiator 21 is mounted on the first transverse beam 11, and the fan 22 is connected to a side of the first radiator 21 facing the second space 102, i.e., the fan 22 is arranged opposite to the motor 30.

Further, the motor 30 includes a heat dissipation cavity, one end of the first radiator 21 is connected to an inlet of the heat dissipation cavity via a circulating pipeline, the other end of the first radiator 21 is connected to an outlet of the heat dissipation cavity via the circulating pipeline, and there is a cooling medium between the first radiator 21 and the heat dissipation cavity of the motor 30, where the cooling medium may be cooling water, and the cooling medium flows in the circulating pipeline.

The first space 101 has an air inlet 103 connected with the motor heat dissipation assembly 20, and during a driving process of the all-terrain vehicle, air flows to the motor heat dissipation assembly 20 via the air inlet 103, which may exchange heat with the cooling medium flowing through the first radiator 21, and the cooling medium may cool the motor 30 after heat exchange.

Compared with the solutions in the related art where a motor heat dissipation assembly is arranged in a front end, the motor heat dissipation assembly 20 is arranged in the middle of the frame 10 in the embodiment of the present application, which can free up a part of front space of the front end of the all-terrain vehicle, reduce the layout difficulty of the head cooling system of the all-terrain vehicle, and further optimize a layout of the whole vehicle. Further, a distance between the motor 30 and the motor heat dissipation assembly 20 can be shortened, to cause a path of the circulating pipeline between the motor 30 and the motor heat dissipation assembly 20 to be shorter, which avoids a loss of cold capacity, improves a heat dissipation effect, and saves costs.

On the basis of the aforementioned embodiments, the all-terrain vehicle further includes a driver seat and a passenger seat, where the driver seat and the passenger seat are arranged side by side in the first space 101 along the second direction, and an upper part of the driver seat and the passenger seat has a large gap along the second direction and is capable of forming the air inlet 103, i.e., the air inlet 103 is formed between the driver seat and the passenger seat.

Accordingly, the first transverse beam 11 is arranged at a rear side of the driver seat and the passenger seat, i.e., the motor heat dissipation assembly 20 is located at the rear side of the driver seat and the passenger seat along the first direction. Further, the motor heat dissipation assembly 20 may be opposite to the air inlet 103. For example, along the second direction, the motor heat dissipation assembly 20 is arranged between the driver seat and the passenger seat, and the first radiator 21 is directly opposite to the air inlet 103. Such an arrangement can prevent the driver seat and the passenger seat from blocking the motor heat dissipation assembly 20, increase a windward side of the motor heat dissipation assembly 20, and enhance a heat dissipation effect of the first radiator 21.

It should be understood that in some embodiments, the first space 101 is only provided with the driver seat, and the motor heat dissipation assembly 20 may be arranged on a side of the driver seat, that is, the air inlet 103 is formed on the side of the driver seat, which is not limited in the embodiments of the present application.

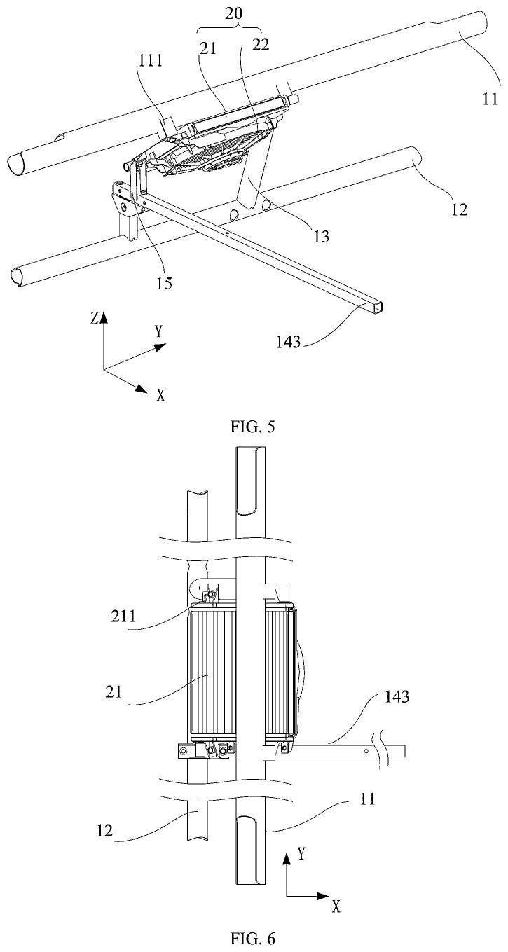

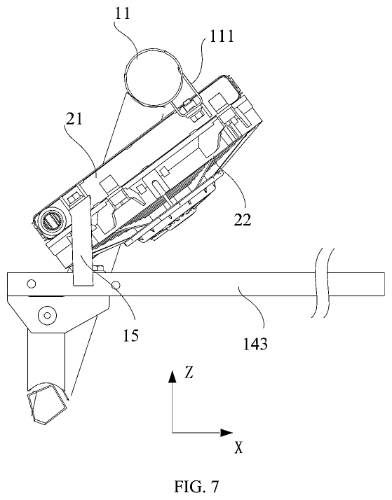

As shown in FIGS. 5 to 7, in the embodiment of the present application, the motor heat dissipation assembly 20 is obliquely arranged on the first transverse beam 11 along the first direction, and an inclined angle ranges from 30° to 60°.

Specifically, in the embodiment of the present application, the first radiator 21 is a rectangular plate structure in overall, which includes a first end and a second end which are oppositely arranged, where the first radiator 21 is arranged obliquely along the first direction, then the first end of the first radiator 21 may be arranged above the second end thereof. The first end of the first radiator 21 is connected to the first transverse beam 11, and a projection of the first end of the first radiator 21 on a first projection plane (a projection plane composed of the first direction and the second direction) is located in the second space 102.

The second end of the first radiator 21 extends obliquely and downward, and a projection of the second end of the first radiator 21 on the first projection plane is located in the first space 101, and an angle range between a connecting line of the first end and the second end of the first radiator 21 and the first projection plane may be 30° to 60°.

Preferably, the angle range between the connecting line of the first end and the second end of the first radiator 21 and the first projection plane may be 45°, i.e. an inclined angle of the first radiator 21 is 45°. Such an arrangement can optimize a layout of the first radiator 21, increase a windward area of the first radiator 21, and increase air flow efficiency, thereby improving a cooling effect of the motor 30.

Further, the second space 102 of the all-terrain vehicle is further provided with the engine 40 which is arranged above the motor 30 along the third direction, and the engine 40 is opposite to the air outlet of the motor heat dissipation assembly 20, i.e., the air outlet of the first radiator 21 is opposite to the engine 40.

With such arrangement, during a driving process of the all-terrain vehicle, air can enter the motor heat dissipation assembly 20 via the air inlet 103 between the driver seat and the passenger seat, and after the air exchange heat with the motor heat dissipation assembly 20, the cooling medium in the first radiator 21 dissipates heat and cools the motor 30, and then the air is blown to the engine 40 below by the fan 22, thereby dissipating heat from the engine 40, reducing heat concentration, and playing a heat dissipation role, thereby improving a cooling effect of the engine 40.

On the basis of the above embodiments, the frame 10 provided by the embodiment of the present application further includes a second transverse beam 12, a support frame 14, and a first support beam 13, where the second transverse beam 12 is arranged below the first transverse beam 11 along the third direction and maintains a certain interval. Along the first direction, a projection of the second transverse beam 12 on the first projection plane is located at a front side of the projection of the first transverse beam 11 on the first projection plane.

The first support beam 13 is arranged between the first transverse beam 11 and the second transverse beam 12, and the first support beam 13 extends along the third direction, and two ends of the first support beam 13 are connected to the first transverse beam 11 and the second transverse beam 12, respectively, in order to enhance structural strength of the frame 10. At the same time, the first support beam 13 may be used for fixing the first radiator 21. It should be noted that the first support beam 13, the first transverse beam 11, and the second transverse beam 12 may be cylindrical steel tubes and the three are welded together to form a H-shape structure.

The support frame 14 may be a steel structure welded from a plurality of square steel tubes, which is a rectangular frame in overall and includes a first frame 141 and a second frame 142 arranged along the first direction and a third frame 143 and a fourth frame 144 arranged oppositely along the second direction, where the first frame 141 is connected to a rear of the frame 10, i.e., one end of the support frame 14 is connected to the rear of the frame 10, and the second frame 142 is arranged below the motor heat dissipation assembly 20 and is arranged close to the fan 22.

One end of the third frame 143 and one end of the fourth frame 144 are connected to the first frame 141, and the other ends are connected to the second frame 142. The third frame 143 and the fourth frame 144 are connected to the second transverse beam 12. The second transverse beam 12 is provided with two connecting seats spaced apart along the second direction, where tops of the connecting seats are connected to the third frame 143 and the fourth frame 144, thereby fixing the support frame 14. It should be noted that each connecting point of the support frame 14 is detachably connected by a fastener, etc.

In the embodiment of the present application, the first radiator 21 of the motor heat dissipation assembly 20 is connected to the first transverse beam 11, the first support beam 13, and the support frame 14, respectively. For example, the first radiator 21 is detachably connected to the first transverse beam 11, the first support beam 13, and the support frame 14 by a fastener, which is not limited in the present embodiment.

In some embodiments, the support frame 14 is provided with a first mounting frame 15, and the first mounting frame 15 is used for connecting the support frame 14 and a bottom of the first radiator 21; the first support beam 13 is provided with a second mounting frame, and the second mounting frame is used for connecting the first support beam 13 and the bottom of the first radiator 21; and the first transverse beam 11 is provided with two first fixing seats 111 spaced apart along the second direction, and is connected to a top of the first radiator 21 via the two first fixing seats 111.

For example, in the embodiment of the present application, the first radiator 21 is a rectangular plate structure in overall, the first radiator 21 is provided with four fixing frames 211, and the four fixing frames 211 are respectively defined as a first fixing frame, a second fixing frame, a third fixing frame, and a fourth fixing frame, where the first fixing frame and the second fixing frame are arranged on the top of the first radiator 21 along the third direction, and the first fixing frame and the second fixing frame are respectively located on two sides of the first radiator 21 along the second direction; i.e., the first fixing frame and the second fixing frame are respectively arranged at the first end of the first radiator 21, and the first fixing frame and the second fixing frame are arranged on left and right sides of the first end along the second direction.

The first fixing frame and the second fixing frame are configured to be connected to the first transverse beam 11. For example, the first transverse beam 11 is provided with at least two first fixing seats 111 spaced apart along the second direction, and the two first fixing seats 111 are arranged close to the first fixing frame and the second fixing frame, respectively. The first fixing frame and the second fixing frame are detachably connected to corresponding first fixing seats 111, for example, the first fixing frame and the second fixing frame are detachably connected to the first fixing seats 111 by fasteners.

Further, the third fixing frame and the fourth fixing frame are arranged at the bottom of the first radiator 21 along the third direction, and the third fixing frame and the fourth fixing frame are respectively located at the two sides of the first radiator 21 along the second direction, i.e., the third fixing frame and the fourth fixing frame are respectively arranged at the second end of the first radiator 21, and the third fixing frame and the fourth fixing frame are arranged at left and right sides of the second end along the second direction.

The third fixing frame and the fourth fixing frame are configured to be connected to the second transverse beam 12 and the first support beam 13, respectively. For example, the support frame 14 is provided with a first mounting frame 15, where the first mounting frame 15 is U-shaped in overall, the first mounting frame 15 extends along the third direction, one end of the first mounting frame 15 is connected to the third frame 143 of the support frame 14, i.e., an open end of the first mounting frame 15 is connected to two side walls of the third frame 143.

The other end of the first mounting frame 15 is connected to the third fixing frame of the first radiator 21, i.e., a closed end of the first mounting frame 15 is connected to the third fixing frame, and the closed end of the first mounting frame 15 is lower than the first transverse beam 11 to keep the bottom end of the first radiator 21 tilted.

In the embodiment of the present application, the first support beam 13 is provided with the second mounting frame, where the second mounting frame is located on a side of the first support beam 13 facing the first radiator 21, the second mounting frame is L-shaped, one side of the second mounting frame is connected to the first support beam 13, and the other side is connected to the fourth fixing frame of the first radiator 21.

It should be noted that the first fixing frame and the second fixing frame mentioned above are located at a same height along the third direction, and tops of the third fixing frame and the fourth fixing frame are located at a same height, and each of the fixing frames 211 is inserted with a fastener to realize that the first radiator 21 is detachably connected. Such an arrangement can facilitate replacement and maintenance of the motor 30 or the fan 22.

On the other hand, in the related art, an all-terrain vehicle generally includes a frame and a roll cage arranged on a top of the frame, where the frame is used for arranging a cab and mounting components such as an engine, etc., and the roll cage is a detachable steel tube assembly, which is often mounted on the top of the frame in the vehicle and plays a part in support, to protect safety of a driver and a passenger in the vehicle when the vehicle rolls over. However, in the related art, problems of the roll cage having poor structural strength and being prone to be deformed and broken may reduce safety of the vehicle. The inventors have found that a reason for these problems is that the roll cage in the related art is a detachable steel tube assembly, and no supporting structure is arranged between a side beam thereof and a frame, resulting in the roll cage's poor ability to resist lateral impacts and rolling impacts. Thus, when the vehicle rolls over, the roll cage is prone to be deformed and broken, affecting the safety of the vehicle.

For the aforementioned technical problems, an embodiment of the present application provides a new roll cage, by arranging a second support beam between a side beam and a middle of a frame, where the frame, the side beam, and the second support beam enclose a closed triangle structure.

Such an arrangement can enhance structural strength of the entire roll cage, thereby improving an ability of the roll cage to withstand lateral impacts and rolling impacts, reducing a risk of deformation and breakage of the roll cage, and improving the safety of the all-terrain vehicle.

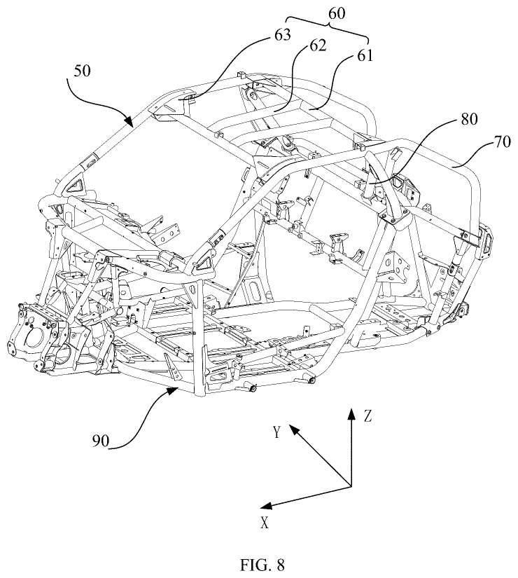

As shown in FIGS. 8 to 10, the all-terrain vehicle provided in the embodiment of the present application includes a frame 90 and a roll cage 50, where the frame 90 is used for arranging a cab and mounting components such as an engine, the roll cage 50 is mounted on a top of the frame 90 along the third direction, and the roll cage 50 plays a supporting role to protect safety of a driver and a passenger in the vehicle when the vehicle rolls over.

Further, the roll cage 50 may be detachably mounted on the top of the frame 90, and the roll cage 50 is composed of a plurality of detachable tubes. For example, in the present embodiment, the roll cage is composed of a plurality of combined steel tube assemblies. Unless otherwise specified, a steel tube may be a round steel tube, which is not limited in the present application. The frame 90 includes a front, a middle, and a rear along a first direction, where a space between the front and the middle of the frame 90 is configured as a cab, and a space between the middle and the rear of the frame 90 may be used for mounting an engine.

As shown in FIG. 11, the front, the middle, and the rear of the frame 90 are respectively provided with first mounting points 710, second mounting points 720, and third mounting points 730 along the first direction. The roll cage 50 may be detachably connected to the front of the frame 90 via the first mounting points 710; the roll cage 50 may be detachably connected to the middle of the frame 90 via the second mounting points 720; and the roll cage 50 may be detachably connected to the rear of the frame 90 via the third mounting points 730.

It should be noted that the first mounting points 710 are arranged on left and right sides of the frame 90 along a second direction, the second mounting points 720 are arranged on the left and right sides of the frame 90 along the first direction, and the third mounting points 730 are arranged on the left and right sides of the frame 90 along the first direction, i.e., the roll cage 50 and the frame 90 are detachably connected via six mounting points, and the detachable connection method includes but is not limited to using fasteners such as plug-in bolts, etc.

Continuing to refer to FIGS. 8 to 10, the roll cage 50 provided in the embodiment of the present application includes a middle beam assembly 60, a support beam assembly, and two side beams 70, where, along the second direction, the middle beam assembly 60 is arranged in the middle of the entire roll cage 50, the two side beams 70 are respectively arranged on left and right sides of the middle beam assembly 60, the middle beam assembly 60 is connected to the side beams 70 on the two sides thereof, and the side beams 70 are connected to the frame 90, thereby connecting the roll cage 50 to the frame 90.

Specifically, the middle beam assembly 60 includes at least two third transverse beams 61, where the third transverse beams 61 may be round steel tubes, the at least two third transverse beams 61 are arranged spaced apart along the first direction, each of the third transverse beams 61 extends along the second direction, and two ends of the third transverse beams 61 are respectively connected to the side beams 70 on two sides thereof.

Further, the support beam assembly is used for connecting the side beams 70 and the frame 90 to enhance structural strength of the entire roll cage 50. The support beam assembly includes at least two second support beams 80, and one second support beam 80 is arranged close to a side beam 70 on each side, where one end of the second support beam 80 is connected to the middle of the frame 90, and the other end of the second support beam 80 extends toward the side beam 70 and is connected to the side beam 70, and the second support beam 80, the frame 90, and the side beam 70 jointly form a closed triangular structure.

It should be noted that, along the second direction, second support beams 80 are arranged between the frame 90 and the side beams 70 on the left and right sides, and closed triangular structures are respective enclosed, i.e., there are triangular structures between the frame 90 and the side beams 70 on the two sides thereof; where a triangle refers to a roughly triangular outline, including but not limited to a regular triangle.

Compared with solutions in the related art where no supporting structure is arranged between a side beam of a roll cage and a frame, which results in poor ability of the roll cage to resist lateral impacts and rolling impacts, in the embodiment of the present application, the second support beams 80 are arranged between the side beams 70 and the middle of the frame 90, and the frame 90, the side beams 70, and the second support beam, 80 enclose closed triangular structure.

Such an arrangement can enhance structural strength of the entire roll cage, thereby improving the ability of the roll cage 50 to withstand lateral impacts and rolling impacts, reducing a risk of deformation and breakage of the roll cage 50, and improving the safety of the all-terrain vehicle.

On the basis of the above embodiments, the middle beam assembly 60 further includes at least one fourth transverse beam 62, where the fourth transverse beam 62 is arranged between two adjacent third transverse beams 61 and extends along the first direction, and two ends of the fourth transverse beam 62 are respectively connected to the third transverse beams 61.

For example, the middle beam assembly 60 includes two third transverse beams 61 spaced apart, two fourth transverse beams 62 are arranged between the two third transverse beams 61, the two fourth transverse beams 62 are spaced apart along the second direction, and two ends of the fourth transverse beams 62 are respectively connected to the third transverse beams 61.

Preferably, the third transverse beams 61 and the fourth transverse beams 62 in the middle beam assembly 60 may be a one-piece structure. Such an arrangement can enhance structural strength of the middle beam assembly 60 and enhance an ability of the roll cage 50 to withstand lateral impacts and rollover impacts.

In order to realize detachable connections between the middle beam assembly 60 and the side beams 70 on the two sides thereof, in the embodiment of the present application, the side beams 70 extend along the first direction, and first mounting seats 74 are arranged on sides of the side beams 70 facing the third transverse beams 61, and the first mounting seats 74 may be welded to the side beams 70; i.e., along the second direction, the first mounting seats 74 are arranged at corresponding connection positions between the side beams 70 and the third transverse beams 61, and the first mounting seats 74 are located on inner sides of the side beams 70.

Accordingly, two ends of the third transverse beams 61 are respectively provided with second mounting seats 63 and are connected to the first mounting seats 74 via the second mounting seats 63, to cause the third transverse beams 61 to be detachably connected to the side beams 70. The first mounting seats 74 have first mounting surfaces, and, along the second direction, the first mounting surfaces are constructed as side surfaces of the first mounting seats 74 facing the second mounting seats 63; the second mounting seats 63 have second mounting surfaces, and, along the second direction, the second mounting surfaces are constructed as side surfaces of the second mounting seats 63 facing the first mounting seats 74, and the first mounting surfaces and the second mounting surfaces are arranged oppositely and fit together along the second direction.

With such arrangement, the first mounting seats 74 and the second mounting seats 63 are in surface contact along the second direction, and connection areas between the middle beam assembly 60 and the side beams 70 can be increased, thereby improving withstanding capacity. When the vehicle rolls over, a lateral impact force withstood by the roll cage 50 is perpendicular to the first mounting surfaces and the second mounting surfaces, which is conducive to transferring the lateral impact force and can reduce a risk of deformation of the roll cage 50.

Furthermore, a plurality of fasteners are arranged between the first mounting seats 74 and the second mounting seats 63, and the first mounting seat 74 and the second mounting seat 63 are detachably connected via the fasteners. A mounting direction of the fasteners is consistent with the second direction. For example, a fastener is configured to be a fastening bolt, and a mounting direction of the fastening bolt (also an axial direction of the fastening bolt) is consistent with the second direction. With such arrangement, the mounting direction of the fasteners is consistent with the second direction. In other words, the mounting direction of the fastener is consistent with a direction of a lateral impact force withstood by each mounting seat.

Compared with the related art where fasteners are mounted along the third direction, in the embodiment of the present application, the mounting direction of the fasteners is consistent with the second direction, which can lower a risk of withstanding, by the fasteners, a large shear force and causing deformation or breakage at the connection, and can improve connection reliability between the middle beam assembly 60 and the side beams 70, thereby improving safety of the vehicle.

On the basis of the above embodiments, in order to further improve the structural strength of the roll cage 50, the support beam assembly in the embodiment of the present application includes two second support beams 80, and the two second support beams 80 are respectively arranged on two sides of the middle of the frame 90 along the second direction.

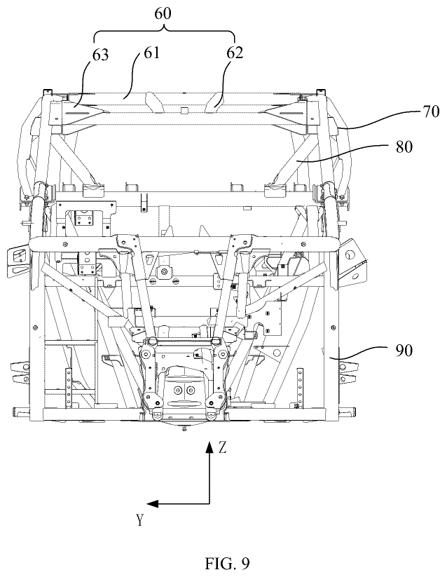

Referring to FIG. 9, the two second support beams 80 are obliquely arranged between the middle of the frame 90 and the side beams 70 along the second direction, and the second support beams 80 includes first ends and second ends arranged oppositely, where the first ends of the second support beams 80 are connected to the frame 90, and the second ends of the second support beams 80 extend obliquely along the second direction toward sides of the side beams 70 and are connected to the side beams 70.

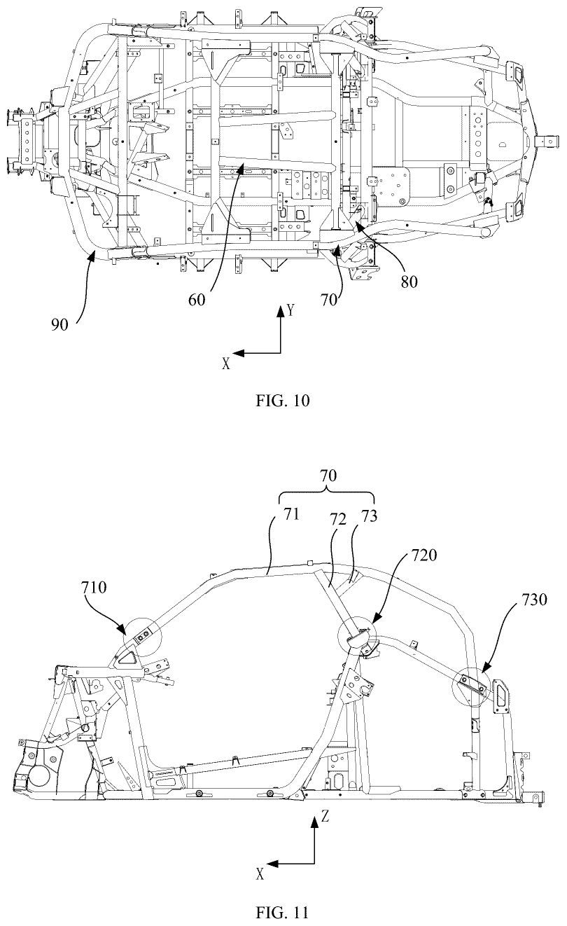

As shown in FIG. 10, the two second support beams 80 are symmetrically arranged along the first direction, the second support beams 80 are obliquely arranged along the first direction, and the first ends of the second support beams 80 are located on sides of the second ends thereof facing the rear of the frame 90. With such arrangement, the second support beams 80 are obliquely arranged, which can decompose a lateral impact force transferred thereto, to improve a withstanding capacity of the second support beams 80.

As shown in FIG. 11, in the embodiment of the present application, the two side beams 70 are symmetrically arranged on the two sides of the middle beam assembly 60 along the first direction, and the two side beams 70 are arranged in a splayed shape from the front to the rear of the frame 90. Further, a width between the two side beams 70 along the second direction gradually decreases from the front to the rear of the frame 90.

Further, each of the side beams 70 includes a first tubular column 71, a second tubular column 72, and at least one third tubular column 73, where the first tubular column 71 extends in overall along the second direction, one end of the first tubular column 71 is connected to a first mounting point 710 of the frame 90, and the other end thereof is connected to a third mounting point 730 of the frame 90, and a middle of the first tubular column 71 bulges upward along the third direction and is connected to the middle beam assembly 60, to cause the frame 90 and the middle beam assembly 60 to form a cab.

The second tubular column 72 is arranged outside the first tube column 71 along the second direction, one end of the second tubular column 72 is connected to the middle of the first tubular column 71, and the other end of the second tubular column 72 extends outward along the second direction and is connected to a second mounting point 720 of the frame 90. With such arrangement, when the vehicle rolls over, the second tubular column 72 can serve as a first force bearing point (in other words, the second tubular column 72 contacts the ground first), which can withstand most of the impact, thereby preventing the first tubular column 71 from withstanding relatively large impact, and improving the safety of the roll cage 50.

The third tubular column 73 is arranged between the first tubular column 71 and the second tubular column 72, the third tubular column 73 is arranged obliquely along the first direction, a top end of the third tubular column 73 is connected to the first tubular column 71, and a bottom end of the third tubular column 73 is connected to the second tubular column 72.

Further, in the embodiment of the present application, the first tubular column 71, the second tubular column 72, and the third tubular column 73 enclose a closed triangular structure. Such an arrangement is beneficial for transferring a lateral impact force and a longitudinal force withstood by the roll cage 50, thereby improving overall strength and stiffness of the roll cage 50.

On the basis of the above embodiments, each of the side beams 70 may include two third tubular columns 73, and the third tubular columns 73 may be symmetrically arranged on two sides of the second tubular column 72 along the first direction. Such an arrangement can improve structural strength of the side beam 70. Preferably, the side beam 70 includes one third tubular column 73, and the third tubular column 73 is arranged on a side of the second tubular column 72 facing the rear of the frame 90 along the first direction. Such an arrangement can improve the structural strength of the side beam 70 and increase a space of the cab at the same time.

For example, the third tubular column 73 is arranged obliquely along the first direction, and the top end of the third tubular column 73 is located on a side of a bottom end of the second tubular column 72 facing the rear of the frame 90, the top end of the third tubular column 73 is connected to the first tubular column 71, the bottom end of the third tubular column 73 is connected to the second tubular column 72, and the first tubular column 71, the second tubular column 72, and the third tubular column 73 enclose a closed triangular structure.

It should be noted that the first tubular column 71, the second tubular column 72, and the third tubular column 73 may be a one-piece structure to enhance the structural strength of the side beam 70. One end of the aforementioned second support beam 80 is connected to the middle of the frame 90, and the other end of the second support beam 80 may be connected to the second tubular column 72, for example, one end of the second support beam 80 is detachably connected to the frame 90, and the other end of the second support beam 80 is detachably connected to the second tube column 72. Such arrangement can facilitate mounting of the second support beam 80.

On the other hand, in the related art, an all-terrain vehicle includes a frame, where the frame is used for arranging a cab and mounting components or devices such as an engine. However, in the related art, in order to improve structural strength of the frame, a large number of transverse beams and connecting beams are arranged, which makes a layout of the frame too cramped, thereby affecting a mounting space of the frame and failing to meet a layout requirement of the whole vehicle. In particular, a layout of a front frame is too cramped, resulting in unreasonable arrangements of a balancing pole, a steering mechanism, and a front axle assembly of the all-terrain vehicle, which cannot meet the layout requirement of the whole vehicle and will also affect structural stability of the frame at the same time.

For the above technical problems, a frame and an all-terrain vehicle is provided in the embodiments of the present application, by arranging a fifth transverse beam between two first support longitudinal beams, two first vertical beam assemblies, the two first support longitudinal beams, and the fifth transverse beam enclose a first mounting space in a triangular shape. Such an arrangement reasonably optimizes a space between a first support frame and a second support frame, and divides the space between the first support frame and the second support frame into the first mounting space and a remaining space located above the first mounting space, thereby facilitating mounting of a balancing pole in the first mounting space, and mounting of other structures in the remaining space, which achieves advantages of reasonably optimizing a mounting space of the frame and improving strength and stiffness of the frame. In addition, another all-terrain vehicle is provided in an embodiment of the present application, by improving a structure of a front frame, where the front frame includes at least a first mounting space, a second mounting space, and a third mounting space, the first mounting space is located above the second mounting space along a third direction, the second mounting space and the third mounting space are arranged sequentially along a first direction, so that the first mounting space, the second mounting space, and the third mounting space form a structure similar to a triangle. Such an arrangement reasonably optimizes a mounting space of the front frame and improves strength and stiffness of the front frame, which improves structure stability of a frame.

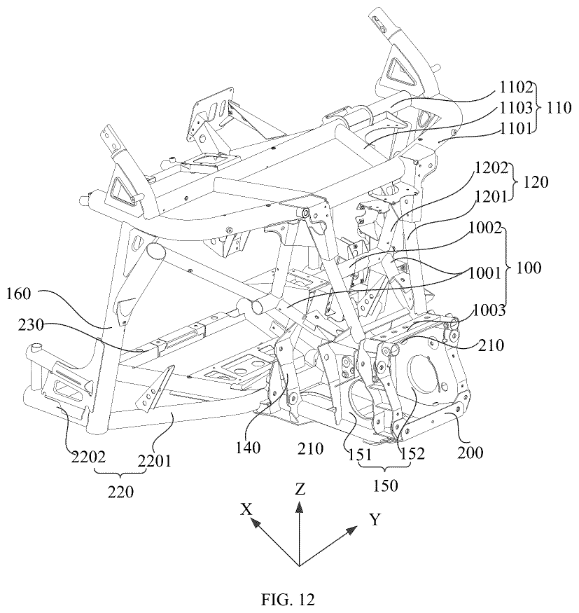

Please refer to FIGS. 12 to 17, a frame includes a first support frame 10, a second support frame 110, and a first vertical beam assembly 120, where the first support frame 100 and the second support frame 110 are spaced apart along a third direction, and the second support frame 110 is located above the first support frame 100.

The first vertical beam assembly 120 is arranged between the first support frame 100 and the second support frame 110, and is used for connecting the first support frame 100 to the second support frame 110. A number of the first vertical beam assembly 120 may be one or two. When there are two first vertical beam assemblies 120, structural strength of the frame can be improved.

In the present embodiment, the first support frame 100 includes two first support longitudinal beams 1001 and a fifth transverse beam 1002. The two first support longitudinal beams 1001 are spaced apart along a second direction, i.e., the two first support longitudinal beams 1001 are spaced apart along a width direction of the frame. The first support longitudinal beam 1001 extends along a first direction, i.e., the first support longitudinal beam 1001 extends along a driving direction of the frame.

The fifth transverse beam 1002 is used for connecting the two first support longitudinal beams 1001, where the fifth transverse beam 1002 may be connected to middles of the two first support longitudinal beams 1001 to divide a space between the first support frame 100 and the second support frame 110 into front and rear parts, which is convenient for mounting of other components of the all-terrain vehicle.

In the present embodiment, each of the first support longitudinal beams 1001 is connected to the second support frame 110 via one first vertical beam assembly 120, i.e., there are two first vertical beam assemblies 120, and the two first vertical beam assemblies 120 are spaced apart along the second direction. In this way, structure strength of the frame can be improved.

Please refer to FIG. 14, the two first vertical beam assemblies 120, the two first support longitudinal beams 1001, and the fifth transverse beam 1002 enclose first mounting spaces in an triangular shape; and the first mounting space is used for mounting a balancing pole 170. For example, the balancing pole 170 includes a first balancing pole, and a second balancing pole and a third balancing pole connected to two ends of the first balancing pole. The first balancing pole and the second balancing pole are perpendicular to each other, and the first balancing pole is arranged cross within the first mounting space and extends outside the first mounting space, to cause the second balancing pole and the third balancing pole to be located outside the first mounting space. The two ends of the first balancing pole are in rotation connection with the two first support longitudinal beams 1001 via rotating bearings respectively. Such an arrangement reasonably optimizes a space between the first support frame 100 and the second support frame 110, and divides the space between the first support frame 100 and the second support frame 110 into the first mounting space and a remaining space located above the first mounting space, thereby facilitating mounting of the balancing pole in the first mounting space and mounting of other structures in the remaining space, thereby achieving advantages of reasonably optimizing a mounting space of the frame and improving strength and stiffness of the frame.

In a possible implementation, the first support frame 100 further includes a sixth transverse beam 1003, where the sixth transverse beam 1003 and the fifth transverse beam 1002 are spaced apart along the first direction, and the sixth transverse beam 1003 is located at a front of the fifth transverse beam 1002.

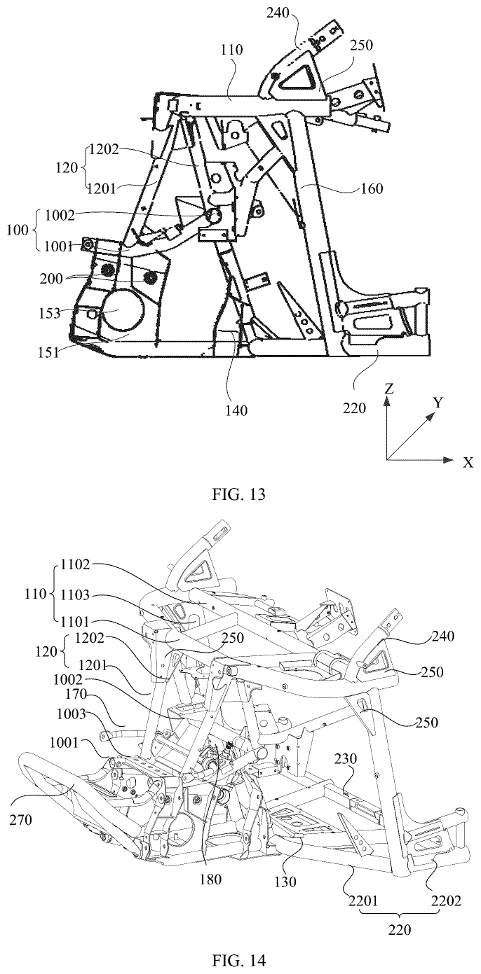

One end of the sixth transverse beam 1003 is connected to one of the first support longitudinal beams 1001, and the other end of the sixth transverse beam 1003 is connected to the other first support longitudinal beam 1001; where the first direction is a driving direction of the frame, i.e., the X direction in FIGS. 12 and 13. In the present embodiment, structural strength of the first support frame 100 can be improved by arranging the fifth transverse beam 1002 and the sixth transverse beam 1003.

Each of the first vertical beam assemblies 120 includes a first vertical beam 1201 and a second vertical beam 1202, and the first vertical beam 1201 and the second vertical beam 1202 are spaced apart along the second direction. One end of the first vertical beam 1201 and one end of the second vertical beam 1202 are connected to one of the first support longitudinal beams 100, and the other end of the first vertical beam 1201 and the other end of the second vertical beam 1202 are connected to the second supporting frame 110.

Along a direction from the first support frame 100 to the second support frame 110, a distance between the first vertical beam 1201 and the second vertical beam 1202 gradually decreases, and ends of the first vertical beam 1201 and the second vertical beam 1202 away from the first support frame 100 intersect at one point, to cause the first vertical beam 1201, the second vertical beam 1202, and the first support longitudinal beam 1001 to form a triangle. In this way, under the premise of reasonably allocating the space between the first support frame 100 and the second support frame 110, stability of the first vertical beam assemblies 120 can be improved, thereby improving the stability of the entire frame.

In a possible implementation, the frame further includes a third support frame 130, where the third support frame 130 is arranged on a side of the first support frame 100 away from the second support frame 110 and is at least connected to the first support frame 100. In one example, the third support frame 130 is connected to the first support frame 100; and in another example, the third support frame 130 is connected to both the first support frame 100 and the second support frame 110. For example, the third support frame 130 is connected to the first support frame 100 via the second vertical beam assembly 140 and a mounting plate assembly 150; and the third support frame 130 is connected to the second support frame 110 via two vertical columns 160. The two vertical columns 160 are spaced apart along the second direction, which can improve safety of the entire frame.

It should be understood that in the present embodiment, the second support frame 110 may be a conventional rectangular frame or other structures. For example, the second support frame 110 may include a U-shaped frame 1101 and a seventh transverse beam 1102 connecting two arms of the U-shaped frame 1101. One end of a vertical column 160 may be connected to the third support frame 130, and the other end of the vertical column 160 may be connected to an arm of the U-shaped frame 1101. A first vertical beam assembly 120 is connected to a connecting arm of the U-shaped frame 1101. In the present embodiment, the second support frame 110 further includes a reinforcing beam 1103, where one end of the reinforcing beam 1103 is connected to the connecting arm of the U-shaped frame 1101, and the other end of the reinforcing beam 1103 is connected to the seventh transverse beam 1102, to improve stability of the second support frame 110. The reinforcing beam 1103 may be arranged obliquely relative to the first direction to improve a withstanding capacity of the reinforcing beam 1103.

In a possible implementation, the frame further includes a second vertical beam assembly 140 and a mounting plate assembly 150; and the mounting plate assembly 150 and the second vertical beam assembly 140 are both used for connecting the second support frame 110 and the third support frame 130.

The second vertical beam assembly 140 and the mounting plate assembly 150 are spaced apart along the first direction, and the mounting plate assembly 150 is away from a front of the second vertical beam assembly 140.

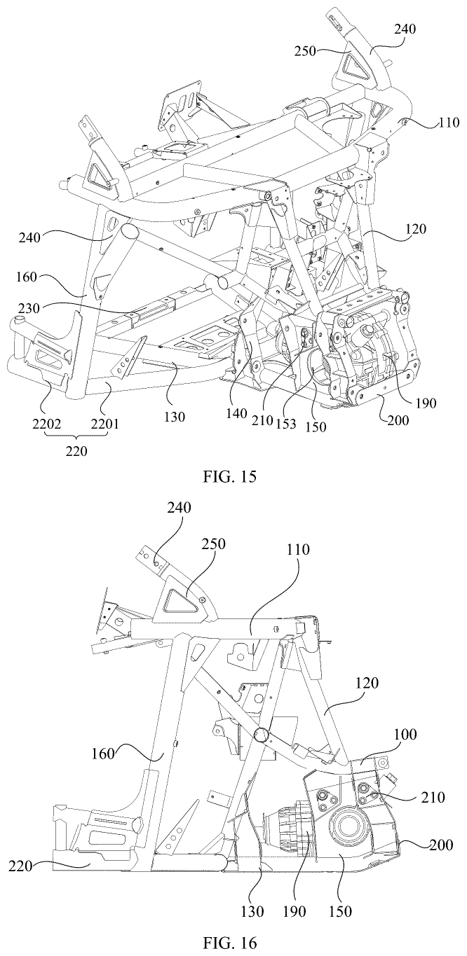

Please continue to refer to FIGS. 14 and 15, in the present embodiment, the second vertical beam assembly 140, the mounting plate assembly 150, the first support frame 100, and the third support frame 130 enclose a second mounting space, and the second mounting space is used for mounting a steering mechanism 180; and the mounting plate assembly 150, the first support frame 100, and the third support frame 130 enclose a third mounting space, and the third mounting space is used for mounting a front axle assembly 190.

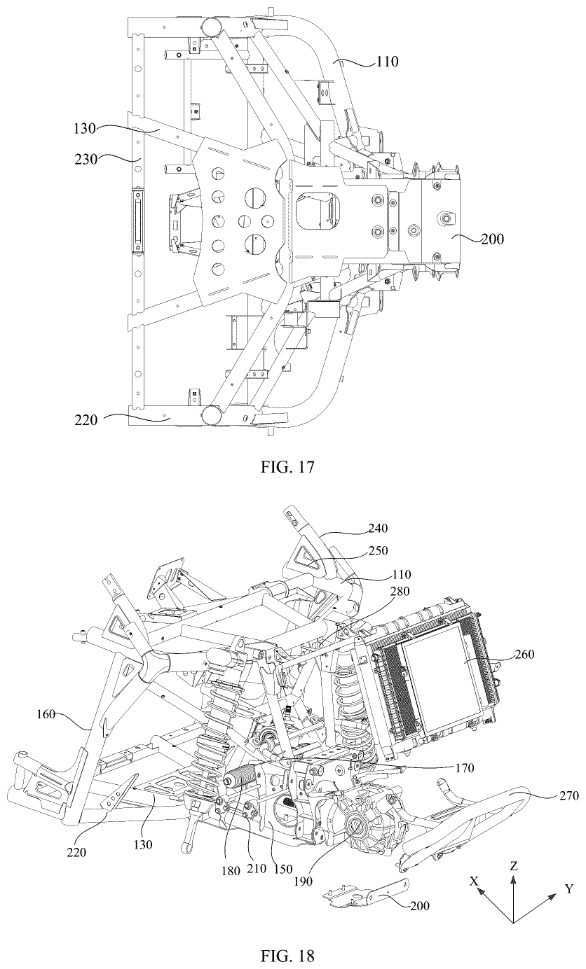

Please refer to FIGS. 16 and 17, the second vertical beam assembly 140, the mounting plate assembly 150, and the fifth transverse beam 1002 cooperate with each other to divide a space between the third support frame 130 and the first support frame 100 to plan the second mounting space and the third mounting space, thereby forming a compact and reliable frame structure.

In a possible implementation, please continue to refer to FIGS. 12 and 13, the second vertical beam assembly 140 includes a third vertical beam and a fourth vertical beam, where the third vertical beam and the fourth vertical beam are spaced apart along the second direction, one end of the third vertical beam and one end of the fourth vertical beam are connected to the first support frame 100, and the other ends are connected to the third support frame 130, which realize a connection between the first support frame 100 and the third support frame 130.

The mounting plate assembly 150 includes a first mounting plate 151 and a second mounting plate 152, where the first mounting plate 151 and the second mounting plate 152 are spaced apart along the second direction, one end of the first mounting plate 151 and one end of the second mounting plate 152 are connected to the third supporting frame 130, and the other end of the first mounting plate 151 and the other end of the second mounting plate 152 are connected to the first supporting frame 100.

The first mounting plate 151 and the second mounting plate 152 are both provided with a mounting hole 153, and the two mounting holes 153 are arranged in counterpoint, i.e., a line of centers of the two mounting holes 153 is parallel to a horizontal plane.

The mounting plate assembly 150, the first support frame 100, and the third support frame 130 enclose the third mounting space, and the third mounting space is used for mounting the front axle assembly 190, i.e., the mounting plate assembly 150 is used for providing an mounting fixing position for the front axle assembly 190. In order to improve stability of the front axle assembly 190, the frame further includes a third mounting plate 200 and at least two mounting supports 210; with such arrangement, the mounting plate assembly 150, the third mounting plate 200 and the at least two mounting supports 210 are all used for connecting with the front axle assembly 190, which can further improve the stability of the front axle assembly 190.

One of the mounting supports 210 is arranged on the first mounting plate 151, and the other mounting support 210 is arranged on the second mounting plate 152 and is located at a side of a mounting hole 153 away from the third support frame 130.

The third mounting plate 200 is arranged at a bottom of the third support frame 130 and is connected to the mounting plate assembly 150; for example, please refer to FIG. 12, the third mounting plate 200 includes a main body and a bent part connected to the main body, and the bent part is bent along the third direction. The main body is detachably connected to the third support frame 130 via a bolt, and the bent part is detachably connected to a front surface of the mounting plate assembly 150 via a bolt.

When actually mounting the front axle assembly 190, the front axle assembly 190 may be first connected to the mounting supports 210, then the front axle assembly 190 may be fixed via the mounting holes 153 of the mounting plate assembly 150, and finally, the third mounting plate 200 may be fixed on the third support frame 130, to cause the bent part of the third mounting plate 200 to be connected to the front axle assembly 190.

In the present embodiment, a number of the at least two mounting supports 210 is four. Two of the mounting supports 210 are arranged on the first mounting plate 151, and the other two mounting supports 210 are arranged on the second mounting plate 152. The two mounting supports 210 located on the first mounting plate 151 are located on two sides of a mounting hole 153 respectively. The two mounting supports 210 located on the second mounting plate 152 are also located on two sides of a mounting hole 153 respectively. Such an arrangement can increase fixing points between the mounting supports 210 and the front axle assembly 190, and further improve stability of the front axle assembly 190.

In a possible implementation, the frame further includes two oblique support members 220, where the oblique support members are spaced apart along the second direction, respectively located on two sides of the third support frame 130, and connected to the third support frame 130. The oblique support members 220 include an oblique support beam 2201 and a second support longitudinal beam 2202. The oblique support beam 2201 is arranged obliquely relative to the first direction, and one end of the oblique support beam 2201 is connected to the third support frame 130 and forms an acute angle with the third support frame 130.

The second support longitudinal beam 2202 is connected to the other end of the oblique support beam 2201, and the second support longitudinal beam 2202 extends along the first direction. In the present embodiment, by providing the two oblique support members 220, the frame can be obliquely supported to improve the stability of the entire frame.

It should be noted that the frame further includes an eighth transverse beam 230, where one end of the eighth transverse beam 230 is connected to one of the second support longitudinal beams 2202, and the other end of the eighth transverse beam 230 is connected to the other second support longitudinal beam 2202, to further improve structural strength of the entire frame.

In this example, the frame further includes a connecting beam 240, where the connecting beam 240 is arranged on the second support frame 110, and the connecting beam 240 is arranged obliquely relative to the second support frame 110, and the connecting beam 240 is used for connecting a mounting frame fixing a windshield.

The frame further includes a reinforcing plate 250, and there may be a plurality of reinforcing plates 250, one of the reinforcing plates 250 is arranged between the first vertical beam assembly 120 and the second support frame 110, and another reinforcing plate 250 may be arranged between the a vertical column 160 and the second support frame 110.

When a front of the frame is subjected to a force, the frame will form three stable and reliable force transferring paths. Specifically, the force will be released via a first force transferring path formed by the third support frame 130, the oblique support beams 2201, the second support longitudinal beams 2202 and the vertical columns 160. The force is also transferred to the vertical columns 160 via the first support longitudinal beams 1001 and to the fifth transverse beam 1002 via the first support longitudinal beams 1001, and then the force is transferred to the second support frame 110 and the connecting beam 240 via the first vertical beam assembly to form a second force transferring path for force release. The force is further transferred to the fifth transverse beam 1002 via the first support longitudinal beams 1001 and then transferred to the second support frame 110 via the first vertical beam assembly 120 and the reinforcing plate 250 to form a third force transferring path for force release. With such arrangement, when the front of the frame is subjected to an impact force, the force can be released through the first force transferring path, the second force transferring path, and the third force transferring path, thereby improving the safety of the frame.

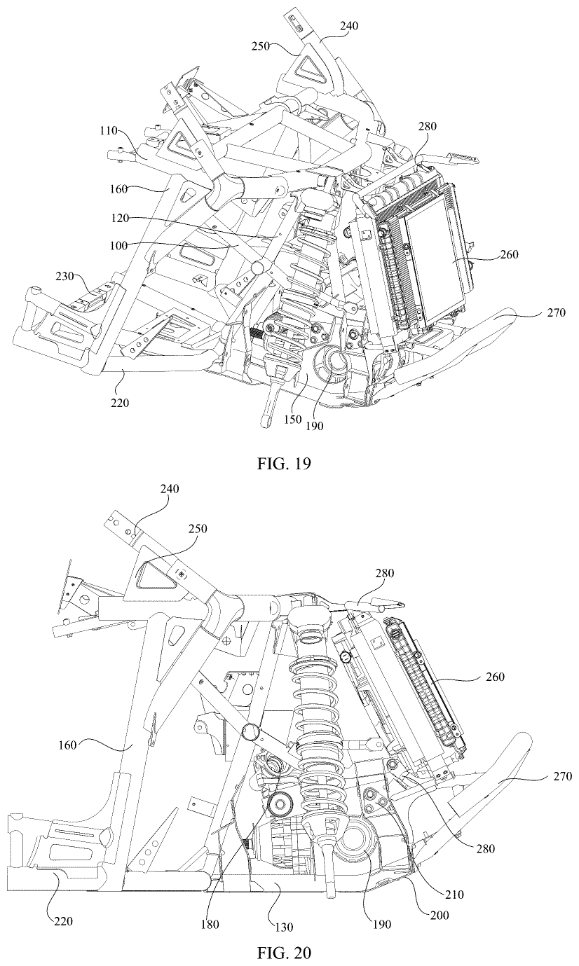

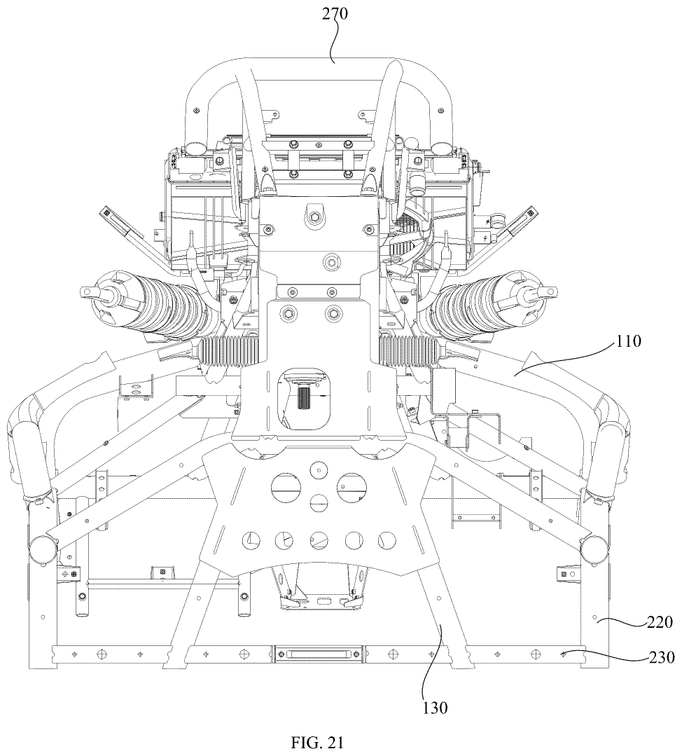

Please refer to FIGS. 18 to 21, an embodiment of the present disclosure further provides an all-terrain vehicle, including the frame described in any of the above embodiments related to FIGS. 12 to 17 and a balancing pole 170, and the balancing pole 170 is mounted in the first mounting space of the frame. Since the all-terrain vehicle provided in the present embodiment includes the frame in any of the above embodiments related to FIGS. 12 to 17, the all-terrain vehicle provided in the present embodiment has all the beneficial effects of the frame, which will not be repeated in the present embodiment.

The all-terrain vehicle further includes a front axle assembly 190, a second radiator 260, a steering mechanism 180, and a bumper 270; where the front axle assembly 190 is mounted in the third mounting space of the frame, and the steering mechanism 180 is mounted in the second mounting space of the frame;

The second radiator 260 is connected to the second support frame 110 and the third support frame 130 of the frame respectively via radiator supports 280, i.e., there are two radiator supports 280, an upper part of the second radiator 260 is connected to the second support frame 110 via one of the radiator supports 280, and a lower part of the second radiator 260 is connected to the third support frame 130 via the other radiator support 280.

The bumper 270 is connected to a front of the third support frame 130, where the bumper 270 may be directly connected to the third support frame 130 or may be indirectly connected to the third support frame 130. For example, the bumper 270 is fixed to the front of the third support frame 130 via the third mounting plate 200.

Please refer to FIGS. 18 to 21, an all-terrain vehicle is further provided in the embodiment of the present application, including a frame, a balancing pole 170, a steering mechanism 180, a front axle assembly 190, and a plurality of wheels supporting the frame (not shown in the drawings), where the frame includes a front frame, a middle frame (not shown in the drawings), and a rear frame (not shown in the drawings) extending along a first direction, the front frame includes at least a first mounting space, a second mounting space, and a third mounting space, the balance bar 170 is mounted in the first mounting space, the steering mechanism 180 is mounted in the second mounting space, and the front axle assembly 190 is mounted in the third mounting space; and the first mounting space is located above the second mounting space along a third direction, and the second mounting space and the third mounting space are arranged sequentially along the first direction. With such arrangement, the first mounting space, the second mounting space, and the third mounting space form a structure similar to a triangle, which reasonably optimizes the mounting space of the frame and improves strength and stiffness of the frame, thereby enhancing structural stability of the frame.

The front frame is the frame described in any of the above embodiments related to FIGS. 12 to 17. Since the front frame provided in the present embodiment is the frame in any of the above embodiments related to FIGS. 12 to 17, the front frame has all the beneficial effects of the frame, which will not be repeated in the present embodiment.

Various embodiments or implementations in the present application are described in a progressive way. Each embodiment focuses on differences from other embodiments, and same or similar parts among the various embodiments may refer to one another.

It should be noted that “one embodiment”, “an embodiment”, “an exemplary embodiment”, “some embodiments”, etc., mentioned in the description, indicate that said embodiment(s) may include a particular feature, structure or characteristic, but each embodiment may not necessarily include that particular feature, structure or characteristic. In addition, such phrases do not necessarily refer to a same embodiment. In addition, when a particular feature, structure, or characteristic is described in combination with an embodiment, an implementation of such a feature, structure or characteristic in combination with other embodiments explicitly or not explicitly described is within the knowledge of those skilled in the art.

In general, a term should be understood, at least in part, by usage thereof in the context where the term is used. For example, depending at least in part on the context, a term “one or more” as used herein may be used to describe any feature, structure, or characteristic in the singular sense or may be used to describe a combination of features, structures, or characteristics in the plural sense. Similarly, terms such as “a (an)”, or “the” may also be construed to convey a singular reference or to convey a plural reference, depending at least in part on the context.

It should be readily understood that terms “on” “above” and “over” in the present disclosure should be interpreted in the broadest manner, so that “on” not only means “directly on something,” but also includes a meaning of “on something” with intervening features or layers therebetween, and “above” or “over” not only includes a meaning of “above something” or “over something”, but also may include a meaning of “above something” or “over something” with no intervening features or layers therebetween (i.e., directly on something).

Finally, it should be noted that the above embodiments are only used to illustrate the technical solutions of the present application, rather than to limit them. Although the present application has been described in detail with reference to the aforementioned embodiments, persons of ordinary skills in the art should understand that: they can still modify the technical solutions described in the aforementioned embodiments, or to make equivalent substitutions for some or all of technical features therein; and these modifications or substitutions do not cause the essence of the corresponding technical solutions to deviate from the scope of the technical solutions in the embodiments of the present application.

1. An all-terrain vehicle, comprising a frame, a motor, and a motor heat dissipation assembly;
wherein the frame comprises a first transverse beam located at a middle thereof along a first direction, a first space is formed between the first transverse beam and a front of the frame, and a second space is formed between the first transverse beam and a rear of the frame;
the motor is arranged in the second space, and the motor heat dissipation assembly is located on a side of the first transverse beam facing the second space; and the first space has an air inlet connected with the motor heat dissipation assembly, and the motor heat dissipation assembly is connected with the motor to cool the motor.

2. The all-terrain vehicle according to claim 1, wherein the first space is provided with a driver seat and a passenger seat along a second direction;
the motor heat dissipation assembly is located at a rear side of the driver seat and the passenger seat along the first direction; and the motor heat dissipation assembly is located between the driver seat and the passenger seat along the second direction, and the air inlet is formed between the driver seat and the passenger seat.

3. The all-terrain vehicle according to claim 1, wherein, along the first direction, the motor heat dissipation assembly is obliquely mounted on the first transverse beam, and an inclination angle ranges from 30° to 60°;
wherein the all-terrain vehicle further comprises an engine;
the engine is arranged in the second space and is located above the motor; and an air outlet of the motor heat dissipation assembly is located opposite to the engine.

4. The all-terrain vehicle according to claim 1, wherein the motor heat dissipation assembly comprises a first radiator and a fan;
the motor has a heat dissipation cavity, one end of the first radiator is connected with an inlet of the heat dissipation cavity;
the other end of the first radiator is connected with an outlet of the heat dissipation cavity, and there is a cooling medium between the motor and the first radiator; and
the first radiator is connected to the first transverse beam, and the fan is arranged on a side of the first radiator facing the second space.

5. The all-terrain vehicle according to claim 4, wherein the all-terrain vehicle further comprises a support frame, a second transverse beam, and a first support beam;
along a third direction, the second transverse beam is arranged below the first transverse beam, and the first support beam is connected between the first transverse beam and the second transverse beam;
the support frame is arranged along the first direction, one end thereof is connected to the rear of the frame, and the other end thereof is connected to the second transverse beam; and
the first radiator is connected to the first transverse beam, the support frame, and the first support beam.

6. The all-terrain vehicle according to claim 5, wherein the support frame is provided with a first mounting frame;
the first mounting frame extends along the third direction, one end of the first mounting frame is connected to the support frame, and the other end of the first mounting frame is connected to a bottom of the first radiator;
the first support beam is provided with a second mounting frame, and the second mounting frame is used for connecting to the bottom of the first radiator;
the first transverse beam is provided with at least two first fixing seats which are spaced apart along a second direction; and
the first fixing seats are used for connecting to a top of the first radiator.

7. The all-terrain vehicle according to claim 5, wherein the first radiator has a first fixing frame, a second fixing frame, a third fixing frame, and a fourth fixing frame;
the first radiator is a rectangular plate structure in overall, the first fixing frame and the second fixing frame are arranged at a top of the first radiator along the third direction, and the first fixing frame and the second fixing frame are respectively located on two sides of the first radiator along the second direction;
the first fixing frame and the second fixing frame are configured to be connected to the first transverse beam;
the third fixing frame and the fourth fixing frame are arranged at a bottom of the first radiator along the third direction, and the third fixing frame and the fourth fixing frame are respectively located on the two sides of the first radiator along the second direction; and
the third fixing frame and the fourth fixing frame are configured to be respectively connected to the support frame and the first support beam.

8. A roll cage, mounted on a top of a frame, wherein the roll cage comprises a middle beam assembly, two side beams, and a support beam assembly;
wherein the two side beams are respectively connected to two sides of the middle beam assembly along a second direction, the middle beam assembly comprises at least two third transverse beams, and two of the third transverse beams are spaced apart along a first direction; the third transverse beams extend along the second direction and two ends thereof are respectively connected to the side beams;
the support beam assembly comprises at least two second support beams, one end of each of the second support beams is respectively connected to the side beams, and other end of each of the second support beams is respectively connected to the frame, and the frame, the side beams, and the second support beams enclose closed triangular structures.

9. The roll cage according to claim 8, wherein the side beams extend along the first direction, and a side of each of the side beams facing the third transverse beams is provided with a first mounting seat;
an end of each of the third transverse beams is provided with a second mounting seat connected to the first mounting seat, the first mounting seat has a first mounting surface, and the second mounting seat has a second mounting surface;
the first mounting surface and the second mounting surface are arranged oppositely and fit together along the second direction;
a fastener is arranged between the first mounting seat and the second mounting seat; and
a mounting direction of the fastener is consistent with the second direction.

10. The roll cage according to claim 8, wherein two of the second support beams are arranged obliquely between the frame and the side beams along the second direction; and
the two of the second support beams are arranged obliquely and symmetrically along the first direction.

11. The roll cage according to claim 8, wherein the middle beam assembly further comprises at least one fourth transverse beam;
wherein the fourth transverse beam is arranged between two adjacent third transverse beams of the third transverse beams, and the fourth transverse beam extends along the first direction;
the two side beams are symmetrically arranged in a splayed shape along the first direction, and a width between the two side beams along the second direction gradually decreases from a front to a rear of the frame;
each of the side beams respectively comprises a first tubular column, a second tubular column, and at least one third tubular column, wherein the first tubular column extends along the first direction, and two ends thereof are respectively connected to the front and the rear of the frame;
the second tubular column is arranged on an outer side of the first tubular column along the second direction, one end of the second tubular column is connected to the first tubular column, and the other end thereof extends along a third direction and is connected to a middle of the frame;
the third tubular column is arranged obliquely along the first direction, one end thereof is connected to the second tubular column, and the other end thereof is connected to the first tubular column, and the first tubular column, the second tubular column, and the third tubular column enclose a closed triangular structure.

12. The roll cage according to claim 11, wherein each of the side beams comprises one third tubular column; and
the third tubular column is arranged on a side of the second tubular column facing the rear of the frame along the first direction.

13. The roll cage according to claim 11, wherein one end of each of the second support beams is connected to the middle of the frame, and the other end thereof is connected to the second tubular column; and
the first tubular column, the second tubular column, and the third tubular column are a one-piece structure.

14. A frame, comprising: a first support frame, a second support frame, and first vertical beam assemblies used for connecting the first support frame to the second support frame;
wherein the first support frame comprises two first support longitudinal beams spaced apart along a second direction and a fifth transverse beam used for connecting the two first support longitudinal beams, and the second direction is a width direction of the frame; each of the first support longitudinal beams is connected to the second support frame via one of the first vertical beam assemblies;
two of the first vertical beam assemblies, the two first support longitudinal beams, and the fifth transverse beam enclose a first mounting space in a triangular shape; and the first mounting space is used for mounting a balancing pole.

15. The frame according to claim 14, wherein the first support frame further comprises a sixth transverse beam, and the sixth transverse beam and the fifth transverse beam are spaced apart along a first direction;
one end of the sixth transverse beam is connected to one of the first support longitudinal beams, and the other end of the sixth transverse beam is connected to the other first support longitudinal beam; wherein the first direction is a driving direction of the frame; and
each of the first vertical beam assemblies comprises a first vertical beam and a second vertical beam spaced apart along the first direction.

16. The frame according to claim 15, wherein the frame further comprises a third support frame, the third support frame is arranged on a side of the first support frame away from the second support frame and is connected to at least the first support frame;
the frame further comprises a second vertical beam assembly and a mounting plate assembly; the second vertical beam assembly and the mounting plate assembly are spaced apart along the first direction, and the mounting plate assembly and the second vertical beam assembly are both used for connecting the first support frame and the third support frame;
the second vertical beam assembly, the mounting plate assembly, the first support frame, and the third support frame enclose a second mounting space, and the second mounting space is used for mounting a steering mechanism;
the mounting plate assembly, the first support frame, and the third support frame enclose a third mounting space, and the third mounting space is used for mounting a front axle assembly.

17. The frame according to claim 16, wherein the second vertical beam assembly comprises a third vertical beam and a fourth vertical beam, the third vertical beam and the fourth vertical beam are spaced apart along the second direction, one end of the third vertical beam and one end of the fourth vertical beam are connected to the first support frame, and the other ends are both connected to the third support frame.

18. The frame according to claim 16, wherein the mounting plate assembly comprises a first mounting plate and a second mounting plate spaced apart along the second direction, one end of the first mounting plate and one end of the second mounting plate are connected to the third support frame, and the other end of the first mounting plate and the other end of the second mounting plate are connected to the first support frame;
the first mounting plate and the second mounting plate are both provided with a mounting hole, and two mounting holes are arranged in counterpoint;
the frame further comprises a third mounting plate and at least two mounting supports; the mounting plate assembly, the third mounting plate, and the at least two mounting supports are used for connecting to the front axle assembly;
the third mounting plate is arranged at a bottom of the third support frame and is connected to the mounting plate assembly;
one of the mounting supports is arranged on the first mounting plate, and the other one of the mounting supports is arranged on the second mounting plate and is located on a side of the mounting holes away from the third support frame.

19. The frame according to claim 16, wherein the frame further comprises two oblique support members, the two oblique support members are spaced apart along the second direction, respectively located on two sides of the third support frame, and connected to the third support frame.

20. An all-terrain vehicle, comprising the frame according to claim 14 and a balancing pole, wherein the balancing pole is mounted in a first mounting space of the frame.
